(19) United States
(12) Patent Application Publication
(10) Pub. No.: US 2024/0011831 A1
(43) Pub. Date: Jan. 11, 2024

(54) FABRY-PEROT CAVITY ARRAY AND SPECTRUM DETECTOR

(71) Applicant: Nanjing Kanshijie Intelligent Technology Co., LTD, Nanjing (CN)

(72) Inventors: Qian MA, Nanjing (CN); Jin YAO, Nanjing (CN); Yuan WANG, Nanjing (CN)

(21) Appl. No.: 18/371,902

(22) Filed: Sep. 22, 2023

Related U.S. Application Data
(63) Continuation of application No. PCT/CN21/88646, filed on Apr. 21, 2021.

(30) Foreign Application Priority Data
Mar. 22, 2021 (CN) 2021103020948

(51) Int. Cl. G01J 3/26; G01J 3/28

(52) U.S. Cl. CPC G01J 3/26; G01J 3/2823; G01J 3/2803; G01J 2003/2813; G01J 2003/2809

(57) ABSTRACT

A Fabry-Perot cavity array and a spectrum detector, where the Fabry-Perot cavity array includes a first element having a first step and a second element having a second step, the first step and the second step are a two-dimensional step structure; a first step side of the first element is arranged opposite to a second step side of the second element, and a step height change direction of the first step is different from a step height change direction of the second step; a step surface of the first step and a step surface of the second step are plated with a reflective film. By fitting two elements having a two-dimensional step structure, a Fabry-Perot cavity array having a three-dimensional step structure is formed, and it is simple in structure and easy to be processed and implemented.

### CROSS-REFERENCE TO RELATED APPLICATIONS

This application is a Bypass Continuation of International Application No. PCT/CN2021/088646, filed on Apr. 21, 2021, which claims priority to Chinese Patent Application No. 202110302094.8, filed on Mar. 22, 2021, the subject matter of which is hereby incorporated herein by reference.

### TECHNICAL FIELD

The present disclosure relates to the technical field of spectrum detectors, and in particular to a Fabry-Perot cavity array and a spectrum detector.

### BACKGROUND

In recent years, miniaturization of spectrum detectors has been a focus of development. At present, one of the most common spectrum detectors is a spectrum detector based on a Fabry-Perot cavity array, where the Fabry-Perot cavity array is a three-dimensional step structure.

In the prior art, the Fabry-Perot cavity array is usually processed by nano fabrication technology such as photolithography, electron beam etching, etc., but the technology is suitable for processing a two-dimensional structure or a simple three-dimensional structure, and it is difficult to realize the processing of a complex three-dimensional structure.

That is, the existing Fabry-Perot cavity array has a complex structure and is difficult to be processed.

### SUMMARY

In view of the above-described problem, the present disclosure provides a Fabry-Perot cavity array and a spectrum detector.

In a first aspect, the present disclosure provides a Fabry-Perot cavity array including: a first element having a first step and a second element having a second step, where the first step and the second step are a two-dimensional step structure; a first step side of the first element is arranged opposite to a second step side of the second element, and a step height change direction of the first step is different from a step height change direction of the second step; and a step surface of the first step and a step surface of the second step are plated with a reflective film.

In other embodiments, the step height change direction of the first step is perpendicular to that of the second step.

In other embodiments, the first step is recessed from a surface of the first element, and the second step is recessed from a surface of the second element; or, the first step protrudes from a surface of the first element, and the second step is recessed from a surface of the second element; or, the first step is recessed from a surface of the first element, and the second step protrudes from a surface of the second element.

In other embodiments, the first step or the second step includes at least two steps having different heights.

In other embodiments, the first step or the second step is a redundant structure, where the redundant structure is used to characterize that among a plurality of steps of the first step or the second step, at least two steps have the same height.

In other embodiments, the reflective film is a single-layer film.

In other embodiments, a material of the first element or the second element is one of the following: glass, quartz, aluminum oxide (Al₂O₃), polymethyl methacrylate (PMMA), and photoresist.

In other embodiments, the Fabry-Perot cavity array further includes a preset number of elements arranged on the first element or the second element, and the preset number of elements are sequentially arranged in series; where each element among the preset number of elements has a two-dimensional step structure, and a step surface of the two-dimensional step structure is plated with a reflective film.

In a second aspect, the present disclosure provides a spectrum detector, including the Fabry-Perot cavity array according to any embodiment of the first aspect and an array detector; where the array detector (i.e., filter array detector) is arranged at a light-out side of the Fabry-Perot cavity array.

In other embodiments, the spectrum detector further includes a collimator arranged at a light-in side of the Fabry-Perot cavity array.

In other embodiments, the array detector is one of the following: a charge-coupled device sensor array, a complementary metal oxide semiconductor sensor array, a thermal sensor array, a photodiode array, an avalanche photodetector array, and a photomultiplier tube array.

In a third aspect, the present disclosure provides a spectrum detection system, including the spectrum detector according to any embodiment of the second aspect and a reconstruction device; where the reconstruction device is configured to perform reconstruction processing on an optical signal outputted by the spectrum detector, so as to obtain spectrum information.

In other embodiments, the system further includes a storage device, where the storage device is used for storing the spectrum information.

In a fourth aspect, the present disclosure provides a terminal device, which is integrated thereon with the spectrum detector according to any embodiment of the second aspect.

In a fifth aspect, the present disclosure provides a method of manufacturing a Fabry-Perot cavity array, including: manufacturing a first element having a first step and a second element having a second step, where the first step and the second step are a two-dimensional step structure; plating a step surface of the first step and a step surface of the second step; and arranging a first step side of the first element opposite to a second step side of the second element, where a step height change direction of the first step is different from a step height change direction of the second step.

In other embodiments, the method further includes: arranging a preset number of elements on the first element or the second element, the preset number of elements being sequentially arranged in series; where each element among the preset number of elements has a two-dimensional step structure, and a step surface of the two-dimensional step structure is plated with a reflective film.

In a six aspect, the present disclosure provides a method of manufacturing a spectrum detector, including: manufacturing a first element having a first step and a second element having a second step, where the first step and the second step are a two-dimensional step structure; plating a step surface of the first step and a step surface of the second step; arranging a first step side of the first element opposite to a second step side of the second element, where a step height change direction of the first step is different from that of the second step; and arranging an array detector at a light-out side of the Fabry-Perot cavity array formed by the first element and the second element.

In other embodiments, the method further includes: arranging a preset number of elements on the first element or the second element, the preset number of elements being sequentially arranged in series; where each element among the preset number of elements has a two-dimensional step structure, and a step surface of the two-dimensional step structure is plated with a reflective film; then the arranging the array detector at the light-out side of the Fabry-Perot cavity array formed by the first element and the second element includes: arranging the array detector at the light-out side of the Fabry-Perot cavity array formed by the preset number of elements, the first element and the second element.

In the Fabry-Perot cavity array and the spectrum detector as provided in the present disclosure, the Fabry-Perot cavity array includes a first element having a first step and a second element having a second step, where the first step and the second step are a two-dimensional step structure; a first step side of the first element is arranged opposite to a second step side of the second element, and a step height change direction of the first step is different from a step height change direction of the second step; and a step surface of the first step and a step surface of the second step are plated with a reflective film. That is, in the embodiments of the present disclosure, a Fabry-Perot cavity array with a three-dimensional step structure is formed by fitting two elements with a two-dimensional step structure, and is simple in structure and can be easily processed and realized.

### BRIEF DESCRIPTION OF DRAWINGS

FIG. 1 is a schematic structural diagram of a spectrum detector based on an array filtering scheme in prior art.

FIG. 2A is a front view of a spectrum detector provided by the present disclosure.

FIG. 2B is a cross-sectional view of the spectrum detector of FIG. 2a taken along a plane A-A provided by the present disclosure.

FIG. 3A is a schematic diagram of a step structure provided by the present disclosure.

FIG. 3B is a schematic diagram of another step structure provided by the present disclosure.

FIG. 4A is a top view of a step structure provided by the present disclosure.

FIG. 4B is a top view of another step structure provided by the present disclosure.

FIG. 4C is a top view of yet another step structure provided by the present disclosure.

FIG. 4D is a top view of still another step structure provided by the present disclosure.

FIG. 4E is a top view of still another step structure provided by the present disclosure.

FIG. 5 is a schematic structural diagram of a Fabry-Perot cavity array provided by the present disclosure.

FIG. 6 is a schematic structural diagram of a spectrum detector in an optical fiber light input manner provided by an embodiment of the present disclosure.

FIG. 7 is a schematic structural diagram of a spectrum detection system provided by the present disclosure.

FIG. 8 is schematic structural diagram of another spectrum detection system provided by the present disclosure.

FIG. 9 is schematic flowchart of a method of manufacturing a spectrum detector provided by the present disclosure.

FIG. 10 is a schematic flowchart of a method of manufacturing a spectrum detector provided by the present disclosure.

### REFERENCE NUMERALS

11: Array detection device; 12: Array filtering device; 13: Parallel light; 21: Incident light; 22: First element; 23: Second element; 24: Array detector; 25: First step reflective film; 26: Second step reflective film; 27: Fitting substance; 31: Recessed step structure; 32: Protruded step structure; 41: Third element; 42: Fourth element; 50: Spectrum detector; 51: Optical fiber; 52: Diffuse reflection sheet.

### DESCRIPTION OF EMBODIMENTS

In order to make the purposes, technical solutions, and advantages of the embodiments of the present disclosure clearer, the technical solutions in the embodiments of the present disclosure will be described clearly and completely below in conjunction with the accompanying drawings in the embodiments of the present disclosure.

Miniaturization of spectrum detectors has been a focus of development in recent years. Existing spectrum detectors are based on three types of schemes below: grating spectroscopy scheme, Fourier transform scheme, and array filtering scheme. Among these schemes, the grating spectroscopy technology is relatively mature, and is a solution for mainstream products, but it is difficult to balance the requirements of performance (e.g., spectrum detection range, resolution, etc.) and miniaturization at the same time. The spectrum detectors based on a traditional Fourier transform scheme are larger in volume and difficult to be miniaturized. Although in recent years, after the adoption of an advanced micro-electro mechanical system (MEMS for short) technology, miniaturized spectrum detectors based on the Fourier transform scheme have also appeared, they are greatly disturbed by the environment due to existence of movable parts thereof, and their resolutions may also be limited when the spectrum detector is small in volume.

The spectrum detectors based on the array filtering scheme generally include only one filter array and one array detector, which is very suitable for highly integrated applications. Meanwhile, the resolution and spectrum detection range of the spectrum detectors based on the array filtering scheme are mainly determined by the number of the filter and a transmission function of the filter, and are not affected by the volume, and they can meet the requirements of performance (wide spectrum detection range, high resolution) and miniaturization at the same time. Also, since the spectrum detector of the array filtering scheme has a compact shape and has no moving part, the spectrum detector is small in size and can be integrated into a portable device, and the portable device includes, for example, a smart phone, a tablet personal computer (PC), a laptop computer, a robot, a drone, a wearable device, etc.

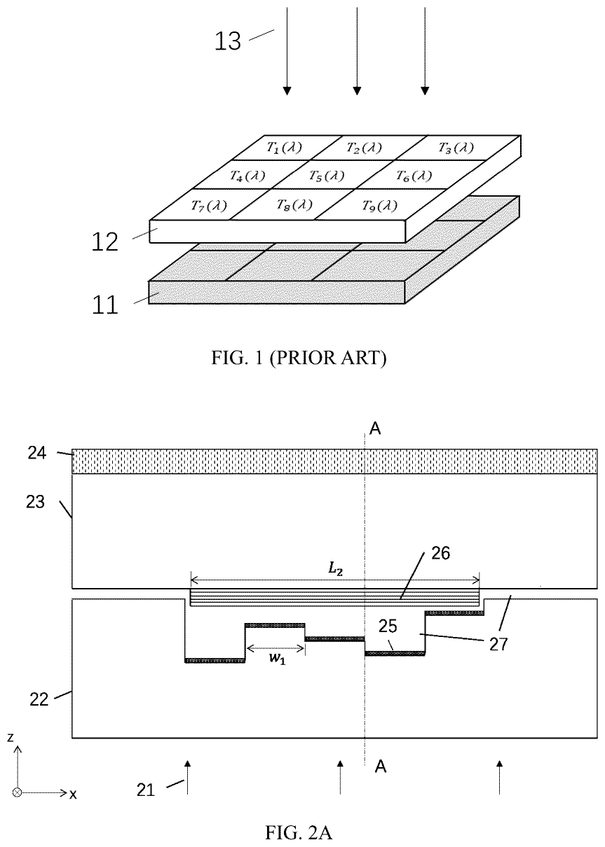

FIG. 1 is a schematic structural diagram of a spectrum detector based on an array filtering scheme in prior art. As shown in FIG. 1, the spectrum detector includes an array detection device 11, and an array filtering device 12, and in an embodiment, the spectrum detector may further include a collimator (not shown in FIG. 1), where the collimator collimates input light through an optical fiber or other similar element to form parallel light 13, and the parallel light 13 is incident to the array filtering device 12; the array filtering device 12 includes a plurality of filter elements with different spectrum transmission functions, and each filter element selectively transmits an optical signal with single or multiple wavelengths and reflects or absorbs an optical signal with other wavelength; and the transmitted optical signal is received by a corresponding pixel unit on the array detection device 11.

Although the spectrum detector based on the array filtering scheme has an advantage of being convenient for miniaturization, the Fabry-Perot cavity array in the spectrum detector based on the array filtering scheme has high production cost and small array number, which cannot meet the requirements for the resolution and the spectrum detection range. At present, a common Fabry-Perot cavity array is a Fabry-Perot cavity array formed by a plurality of Fabry-Perot cavities. In order to enable a spectrometer with the Fabry-Perot cavity array to have the performance of a traditional grating spectroscopic spectrometer, it is necessary to carry hundreds of Fabry-Perot cavities with different thicknesses on the same photosensitive chip. Specifically, the Fabry-Perot cavity array is a three-dimensional step structure, and the thickness of the step varies from tens of nanometers to hundreds of microns.

Since most of the existing micro or nano processing technology, such as photolithography, electron beam etching, etc., are applicable to the processing of two-dimensional structures or simple three-dimensional structures, the processing of complex three-dimensional structures is difficult to be realized. For example, a Fabry-Perot cavity array having 100 Fabry-Perot cavities can be produced by a method of electron beam exposure of polymethyl methacrylate (PMMA). However, it is difficult to further increase the number of the Fabry-Perot cavity in the Fabry-Perot cavity array due to the disadvantages of the electron beam exposure such as small size and slow speed, and the method is not suitable for mass production. For another example, the prior art also adopts a photolithography technical scheme, i.e., multiple exposures. However, this scheme has a long process flow, requires multiple masks for overlaying (i.e., repeating exposure, etching and other processes for multiple times), and has high production cost, and thus it is also difficult to break through the limitation on the number of the Fabry-Perot cavity in the Fabry-Perot cavity array. To sum up, the existing Fabry-Perot cavity array has the problem of complex structure and difficult processing.

In view of the above problems, a technical concept of the present disclosure lies in that: separately processing two elements with a two-dimensional step structure and then fitting the two elements in different directions of the step structure to implement a three-dimensional step structure of a Fabry-Perot cavity array, which is simple in structure and is easy to be processed, and thus a Fabry-Perot cavity array including hundreds of Fabry-Perot cavities can be easily realized.

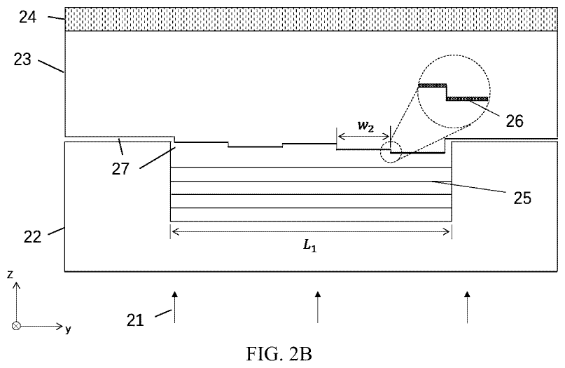

FIG. 2a is a front view of a spectrum detector provided by the present disclosure, and FIG. 2b is a cross-sectional view of the spectrum detector of FIG. 2a taken along a plane A-A provided by the present disclosure.

In a first aspect, an example of the present disclosure provides a Fabry-Perot cavity array. Referring to FIGS. 2a and 2b, the Fabry-Perot cavity array includes a first element 22 having a first step and a second element 23 having a second step, where the first step and the second step are a two-dimensional step structure; a first step side of the first element 22 is arranged opposite to a second step side of the second element 23, and a step height change direction of the first step 22 is different from a step height change direction of the second step 23; and a step surface of the first step 22 and a step surface of the second step 23 are plated with a reflective film.

Specifically, the first step of the first element 22 is a two-dimensional step structure, and includes N₁ (N₁=5 in FIG. 2a) steps, with a step width w₁ and a step length L₁, where the step length L₁ is approximate to a photosensitive size of an array detector 24, and is generally in a range of 0.2 mm-5 mm, the step width w₁ is in a range of 5 um-500 um, and the number of the steps, N₁, is in a range of 2-50.

Each step height of the first step is in an order of micron, and may be produced by gray-scale lithography, laser direct writing, additive manufacturing, and precision machining and other processes. Among these processes, the additive manufacturing and the laser direct writing are convenient and fast, with lower processing costs, and after the processing of step element molds are completed, a low-cost mass production can be realized subsequently by a transfer technology such as nano-imprinting.

The second step of the second element 23 is also a two-dimensional step structure, and includes N₂ (N₂=5 in FIG. 2b) steps, with a step width w₂ and a step length L₂, where the step length L₂ is in a range of 0.2 mm-5 mm, the step width w₂ is in a range of 5 um to 500 um, and the number of the steps, N₂, is in a range of 2 to 50.

Each step height of the second step may be set in an order of micron or nanometer according to a specific working wavelength range of the spectrum detector. For example, if the working wavelength range is in a mid-infrared wave band (wavelength in a range of 2 um-16 um), the step height is in an order of micron, and the processing method is the same as that of the first element 22; if the working wavelength range is in ultraviolet, visible and near-infrared wave bands (wavelength in a range of 100 nm-2 um), the step height is in an order of nanometer, and then more precise thickness control is required during processing, such as exposure by using gray-scale electron beam, overlaying by lithography machine in cooperation with etching equipment, plating by mask in cooperation with PVD (physical vapor deposition) (e.g., magnetron sputtering, electron beam evaporation, etc.). Subsequent manufacture after coming out of the mold by the above method may adopt a transfer technology such as nano-imprinting or thermal imprinting to realize low-cost mass production.

As an embodiment, a material of the first element 22 or the second element 23 is one of the following: glass, quartz, aluminum oxide (Al₂O₃), PMMA and photoresist.

Specifically, the materials used for the first element 22 and the second element 23 need to be transparent in an optical wave band to be measured, and common materials include transparent media such as glass, quartz, aluminum oxide (Al₂O₃), etc., or polymers such as PMMA, photoresist, etc.

The first step side of the first element 22 is arranged opposite to the second step side of the second element 23. Specifically, the first step side fits with the second step side by a fitting substance 27 or other physical or chemical means. In an embodiment, the fitting substance 27 may be an ultraviolet curing glue (UV glue), and the first step side of the first element 22 fits with the second step side of the second element 23 by the UV glue. In an embodiment, an inclination angle between the first element and the second element after fitting in an up-and-down direction. In addition, during fitting, it is necessary to determine that a step height change direction of the first step is different from that of the second step, so that a Fabry-Perot cavity array with a three-dimensional step structure is finally formed. As an embodiment, the step height change direction of the first step is perpendicular to that of the second step.

In the present embodiment, the step surface of the first step and the step surface of the second step are plated with a reflective film. As shown in FIG. 2a, a first step reflective film 25 is coated on the step surface of the first step, and a second step reflective film 26 is coated on the step surface of the second step. When plating the reflective film on the steps, a plating material may be a single-layer metal or a dielectric with a high refractive index (such as Al, Au, Ag, Si, TiO₂, etc.), and a plating method may be electron beam evaporation, thermal evaporation, magnetron sputtering, etc., and during the plating process, a thickness of a film to be plated may be adjusted according to the need for reflectivity; another plating method is using a multilayer dielectric film structure to enhance the reflectivity.

In an embodiment, the reflective film is a single-layer film. Specifically, based on the spectrum reconstruction algorithm used in the present disclosure, high reflectivity is not required to ensure that transmission wavelengths of individual Fabry-Perot cavities do not overlap each other, and thus a single-layer thin film is used, which is less costly. In an embodiment, the single-layer film is an aluminum film or a silver film, and the thickness of the film can be adjusted during plating to control the reflectivity in the visible light range to be 10%-70%.

Accordingly, the first step reflective film 25, the second step reflective film 26, and the fitting substance 27 constitute a Fabry-Perot cavity array, and incident light oscillates multiple times in the Fabry-Perot cavities. In an embodiment, each Fabry-Perot cavity in the Fabry-Perot cavity array allows multiple wavelengths in a detected spectrum range to pass therethrough, and subsequently, spectra in a wide spectrum band range are reconstructed by a spectrum reconstruction method, thereby obtaining spectrum information of the detected light.

As an embodiment, the first step is recessed from a surface of the first element, and the second step is recessed from a surface of the second element; or the first step protrudes from a surface of the first element, and the second step is recessed from a surface of the second element; or the first step is recessed from a surface of the first element, and the second step protrudes from a surface of the second element.

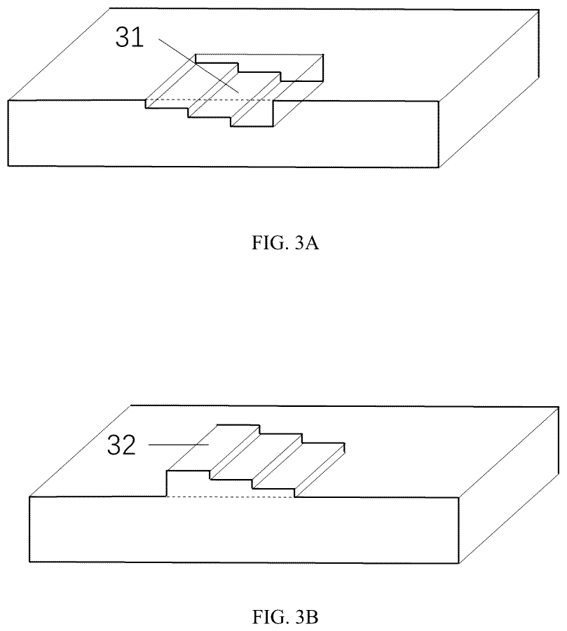

Specifically, FIG. 3a is a schematic diagram of a step structure provided by the present disclosure, and FIG. 3b is a schematic diagram of another step structure provided by the present disclosure. As shown in FIGS. 3a and 3b, the step structure may protrudes from or be recessed from the surface of an element. Where both the first element 22 and the second element 23 may be a recessed step structure 31 as shown in FIG. 3a, i.e., the step structure is recessed from the surface of the element; or when either one of the first element 22 and the second element 23 is a protruded step structure 32 as shown in FIG. 3b, the other element is a recessed step structure 31 as shown in FIG. 3a.

As an embodiment, the first step or the second step includes at least two steps having different heights. Specifically, that first step includes a plurality of steps, at least two of which are different in height; or the second step includes a plurality of steps, at least two of which are different in height.

As an embodiment, the first step or the second step is a redundant structure, where the redundant structure is used to characterize that among the plurality of steps of the first step or the second step, at least two steps have the same height.

Specifically, in the first step or the second step, there are two or more steps having the same height among the steps forming the step structure.

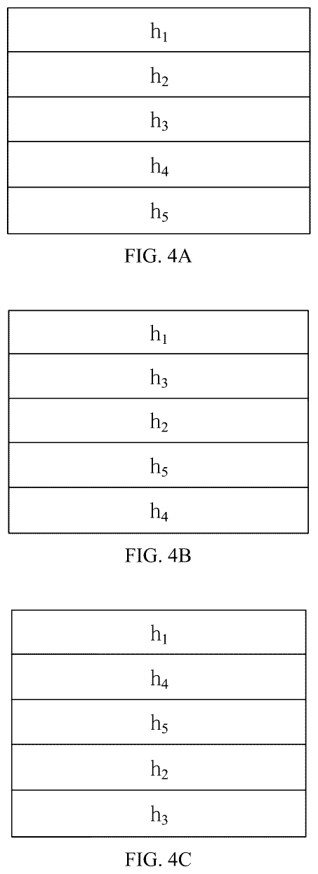

FIG. 4a is a top view of a step structure provided by the present disclosure, FIG. 4b is a top view of another step structure provided by the present disclosure, FIG. 4c is a top view of yet another step structure provided by the present disclosure; FIG. 4d is a top view of still another step structure provided by the present disclosure, and FIG. 4e is a top view of still another step structure provided by the present disclosure. Where h₁, h₂, h₃, h₄, and h₅ respectively represent different step heights. Assuming that h₁>h₂>h₃>h₄>h₅, the step structure may be formed according to the gradually decreased step heights as shown in FIG. 4a; or different heights of the steps can be set arbitrarily as shown in FIGS. 4b and 4c; or the step structure may have a redundant structure (i.e., there are a number of steps with the same step height) as shown in FIGS. 4d and 4e, and spectra derived from the redundant structure may have a check function (including simple check and complex check algorithm), so as to be used for error correction.

It should be noted that, although only five design schemes of the step structures, such as those shown in FIG. 4a to FIG. 4e, are set forth herein, it will be understood by one having ordinary skill in the art that other combinations with different step heights are feasible, as long as that they satisfy the requirement of having two different heights.

As an embodiment, the Fabry-Perot cavity array further includes a preset number of elements arranged on the first element or the second element, and the preset number of elements are sequentially arranged in series, where each element in the preset number of elements has a two-dimensional step structure, and a step surface of the two-dimensional step structure is plated with a reflective film.

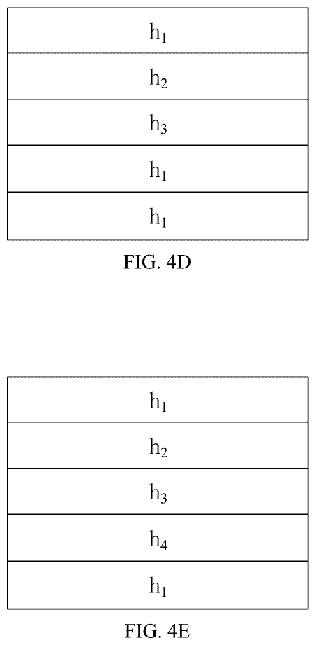

FIG. 5 is a schematic structural diagram of a Fabry-Perot cavity array provided by the present disclosure. As shown in FIG. 5, the Fabry-Perot cavity array includes a first element 22 and a second element 23, and a step side of the first element 22 is arranged opposite to a step side of the second element 23 to form a Fabry-Perot cavity a. The Fabry-Perot cavity array further includes a preset number of elements arranged on the first element 22 or the second element 23 (FIG. 5 shows an example of being provided on the second element 23), where the preset number may be greater than or equal to 1, such as a third element 41, a fourth element 42, . . . a Nth element (not shown) in FIG. 5, and each of the (N−2) elements has a two-dimensional step structure, which is similar to the structures of the first element 22 and the second element 23. As can be seen from FIG. 5, when the third element 41 is superimposed on the second element 23, the second element 23 and the third element 41 may form a Fabry-Perot cavity b; when the fourth element 42 is superimposed on the third element 41, the third element 41 and the fourth element 42 may form a Fabry-Perot cavity c; another element having a two-dimensional step structure may be further superposed on the fourth element 42 to form another Fabry-Perot cavity; and so on to form an array of series-connected Fabry-Perot cavities.

In addition, it should be noted that, except that the step sides of the first element 22 and the third element 23 need to be arranged opposite to each other, the step sides of any other two adjacent elements may be arranged opposite to each other or may not be arranged opposite to each other. For example, a step side of the third element 41 and a step side of the fourth element 42 in FIG. 5 are arranged opposite to each other, and the step side of the second element 23 and the step side of the third element 41 are not arranged opposite to each other.

It should be noted that, compared to the fact that a transmission function of a single Fabry-Perot cavity unit can only be designed with a single thickness parameter, series-connected Fabry-Perot cavities may have many design dimensions (multiple thicknesses). Therefore, the series-connected Fabry-Perot cavities can be more freely designed with different transmission functions, which can both increase the resolution and expand or limit the spectrum detection range as required.

The Fabry-Perot cavity array provided by the present embodiment includes a first element having a first step and a second element having a second step, where the first step and the second step are a two-dimensional step structure; a first step side of the first element is arranged opposite to a second step side of the second element, and a step height change direction of the first step is different from that of the second step; and a step surface of the first step and a step surface of the second step are plated with a reflective film. That is, in the embodiment of the present disclosure, a Fabry-Perot cavity array with a three-dimensional step structure is formed by fitting two elements with a two-dimensional step structure, and is simple in structure and can be easily processed and realized.

In a second aspect, the present disclosure provides a spectrum detector. Referring to FIGS. 2a and 2b, the spectrum detector includes the Fabry-Perot cavity array according to any embodiment of the first aspect and an array detector 24, where the array detector 24 is arranged at a light-out side of the Fabry-Perot cavity array.

Specifically, in the present embodiment, the array detector 24 is located at the light-out side of the Fabry-Perot cavity array, and each detector in the array detector 24 may be configured to receive signal light transmitted from a single Fabry-Perot cavity in the Fabry-Perot cavity array.

In an embodiment, the array detector 24 fits with the Fabry-Perot cavity array. Specifically, the array detector 24 may be closely fitted with the Fabry-Perot cavity array (e.g., the second element 23 shown in FIG. 2a), or they may be fixed by a mechanical structure. After fitting with each other, a distance from the Fabry-Perot cavity array to the array detector 24 needs to be controlled within 1 mm, so as to ensure that there is no obvious out-of-focus phenomenon, and a volume of the spectrum detector is also reduced as much as possible.

As an embodiment, the array detector 24 is one of the following: a charge-coupled device sensor array, a complementary metal oxide semiconductor sensor array, a thermal sensor array, a photodiode array, an avalanche photodetector array, and a photomultiplier tube array.

Specifically, the array detector 24 may be an image detector and/or a light intensity detector. For example, the array detector 24 may be a charge coupled device (CCD) sensor, a complementary metal oxide semiconductor (CMOS) sensor, a thermal sensor, a photodiode array, an avalanche photodetector (APD) array, a photomultiplier tube (PMT) array, or the like.

A working principle of the spectrum detector provided by the present embodiment is as follows. First, the incident light 21 oscillates repeatedly in the fitting substance 27 between the first element 22 having the first step and the second element 23 having the second step, forming a Fabry-Perot resonant cavity. Fabry-Perot cavities at different positions in space have different cavity thicknesses, thereby forming a Fabry-Perot cavity array.

Where a transmission function of any one of the Fabry-Perot cavities in the Fabry-Perot cavity array is as follows:

$$t [ d , v ] = \frac{1}{1 + \frac{4 R}{{( 1 - R )}^{2}} {sin}^{2} ( 2 π n \cdot v \cdot d )} \qquad ( 1 )$$

where d is a thickness of a corresponding Fabry-Perot cavity, v is a wavenumber, R is reflectivity of the Fabry-Perot cavity, and n is a refractive index of a cavity medium (i.e., the fitting substance 27).

The optical signal outputted from the array detector is as follows:

$$y [ d ] = {\sum }_{v = v 0}^{v = v 1} t [ d , v ] \cdot x [ v ] \qquad ( 2 )$$

where y is a reading of array detector and x is an incident spectrum signal.

If the step structure is as shown in FIGS. 4d and 4e, i.e., when there is redundancy in the step structure, signals from the Fabry-Perot cavities with the same height can be averaged to be applied to the above Equation (2).

Equation (2) can also be written in an equivalent matrix form as follows:

Y_{N×1}=T_{N×M}×X_{M×1} (3)
where T is a transformation matrix, calculated by Equation (1) at different thicknesses d and wavenumbers v; and where N is the number of Fabry-Perot cavities in the array, and M is the number of wavelength/wavenumber channels in a spectrum range to be measured.

If the number of samples N is equal to the number of channels to be measured M, the spectrum can be obtained by a simple matrix inversion:

X=T⁻¹Y (4).

The matrix inversion solution method may be greatly affected by measurement noise, and thus the accuracy of the reconstructed spectrum data may be improved by regularization, so as to reduce the noise influence.

The spectrum reconstruction can be implemented by solving the following optimization equation (l=1 or 2):

arg min∥Y−T×X∥₂²+α∥X∥ₜ^{t} (5).

The above optimal solution method of the spectrum reconstruction is also applicable to the case that the number of samples N is less than the number M of channels to be measured. For example, the optimization problem of l=1 can restore the spectrum signal satisfying a sparsity condition in a case where the number of samples N is far less than the number to be measured M.

The reconstruction and storage of the spectrum information may be completed by a lower computer, a personal terminal such as a PC or a mobile phone, a cloud terminal, and the like according to actual application requirements.

The spectrum detector provided by the present embodiment includes a Fabry-Perot cavity array and an array detector that is arranged at a light-out side of the Fabry-Perot cavity array, where the Fabry-Perot cavity array includes a first element having a first step and a second element having a second step, the first step and the second step are a two-dimensional step structure; a first step side of the first element is arranged opposite to a second step side of the second element, and a step height change direction of the first step is different from that of the second step; and a step surface of the first step and a step surface of the second step are plated with a reflective film. That is, in the embodiments of the present disclosure, a Fabry-Perot cavity array with a three-dimensional step structure is formed by fitting two elements with the two-dimensional step structure, and is simple in structure and can be easily processed and realized.

On the basis of the foregoing embodiments, the spectrum detector includes a collimator, a Fabry-Perot cavity array and an array detector, where the array detector is arranged at a light-out side of the Fabry-Perot cavity array, and the collimator is arranged at the light-in side of the Fabry-Perot cavity array; where the Fabry-Perot cavity array includes a first element having a first step and a second element having a second step, the first step and the second step are a two-dimensional step structure; the first step side of the first element is arranged opposite to the second step side of the second element, and a step height change direction of the first step is different from that of the second step; and the step surfaces of the first and second steps are plated with a reflective film.

The present embodiment differs from the foregoing embodiments in that the present embodiment further includes a collimator arranged at the light-in side of the Fabry-Perot cavity array. Specifically, the collimator is configured to process an incident light into a parallel light. In an embodiment, the collimator includes two input modes, i.e., spatial light input and optical fiber input.

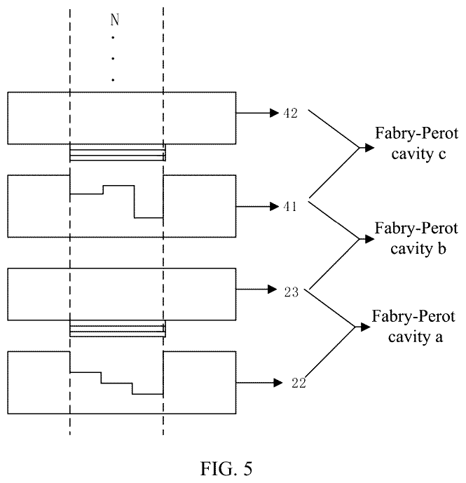

FIG. 6a is a schematic structural diagram of a spectrum detector in an optical fiber light input manner provided by an embodiment of the present disclosure, and FIG. 6b is a schematic structural diagram of a spectrum detector in a spatial light input manner provided by an embodiment of the present disclosure. As shown in FIG. 6a, a spectrum detector 50 may be configured to receive an incident light 21 via a port of an optical fiber 51. Alternatively, as shown in FIG. 6b, the spectrum detector 50 may be configured to directly receive the incident light 21 through the diffuse reflection sheet 52. That is, An array filter may be configured to receive incident light in any manner.

The spectrum detector provided by the embodiments of the present disclosure include a collimator, a Fabry-Perot cavity array, and an array detector, where the array detector is arranged at a light-out side of the Fabry-Perot cavity array; the collimator is arranged at the light-in side of the Fabry-Perot cavity array; where the Fabry-Perot cavity array includes a first element having a first step and a second element having a second step, the first step and the second step are a two-dimensional step structure; a first step side of the first element is arranged opposite to a second step side of the second element, and a step height change direction of the first step is different from that of the second step; and a step surface of the first step and a step surface of the second step are plated with a reflective film. That is, in the embodiments of the present disclosure, the Fabry-Perot cavity array with a three-dimensional step structure is formed by fitting two elements with the two-dimensional step structure, and is simple in structure and can be easily processed and realized.

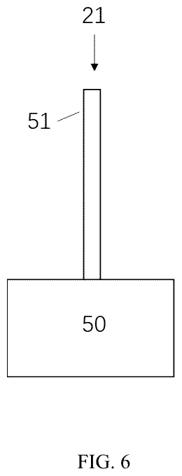

In a third aspect, examples of the present disclosure provide a spectrum detection system. FIG. 7 is a schematic structural diagram of a spectrum detection system provided by the present disclosure. As shown in FIG. 7, the spectrum detection system includes the spectrum detector according to any embodiment of the second aspect and a reconstruction device, where the reconstruction device is configured to reconstruct an optical signal outputted by the spectrum detector, so as to obtain spectrum information.

Specifically, a parallel light beam passes through the Fabry-Perot cavity array to form a corresponding spectrum electrical signal on the array detector, and then the spectrum electrical signal passes through the reconstruction device to be reconstructed into corresponding spectrum information. In an embodiment, the reconstruction device includes a sensor IC (integrated circuit) and a lower computer.

As an embodiment, the system further includes a storage device for storing the spectrum information. Specifically, the storage device may be a personal terminal or a cloud. After the reconstruction device acquires the spectrum information, the spectrum information may be uploaded to a personal terminal or a cloud for storage.

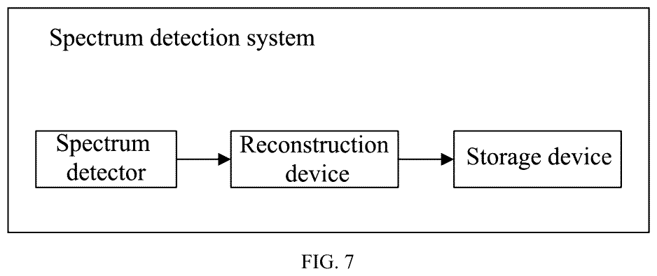

FIG. 8 is a schematic structural diagram of another spectrum detection system provided by the present disclosure. As shown in FIG. 8, the spectrum detection system includes a spectrum detector formed by a collimator, a Fabry-Perot cavity array and an array detector, and further includes a reconstruction device formed by a sensor IC and a lower computer, and a storage device formed by a personal terminal or a cloud. An optical signal collected by the array detector is processed by the sensor IC and the lower computer, and then uploaded to a personal terminal device such as a PC or a mobile phone, or transmitted to a cloud, where the signal collected by the array detector can be restored to spectrum information by a reconstruction algorithm, and the reconstruction algorithm is executed by a lower computer, or may be executed by one of a personal terminal and a cloud terminal. Data of the spectrum information is stored in the personal terminal or the cloud terminal.

It can be clearly understood by one having ordinary skill in the art that for convenience and brevity of description, for a specific working process and corresponding beneficial effects of the spectrum detection system described above, reference may be made to the corresponding processes in the foregoing method examples, and they will not be repeated herein.

The spectrum detection system provided in the present disclosure includes the spectrum detector according to the second aspect and a reconstruction device, where the reconstruction device is configured to perform reconstruction processing on the optical signal outputted by the spectrum detector, so as to obtain spectrum information. That is, in the spectrum detector of embodiments of the present disclosure, by fitting two elements with a two-dimensional step structure, a Fabry-Perot cavity array with a three-dimensional step structure is formed, which is simple in structure and can be easily processed and realized; in addition, by the reconstruction algorithm, a higher resolution of the incident light spectrum is obtained and the incident light with a wider spectrum range is detected, under the condition of having the same number of filter.

In a fourth aspect, the present disclosure provides a terminal device, which is integrated thereon with the spectrum detector according to any embodiment of the second aspect.

Specifically, the spectrum detector according to the second aspect meets the miniaturization requirement, and can be integrated onto a terminal device, such as a portable device, for example, a smart phone, a tablet personal computer (PC), a laptop computer, a robot, a drone, a wearable device, and the like.

It can be clearly understood by one having ordinary skill in the art that for convenience and brevity of description, for a specific working process and corresponding beneficial effects of the terminal device described above, reference may be made to the corresponding processes in the foregoing method examples, and they will not be repeated herein.

For the terminal device provided by the present disclosure, the spectrum detector described above is integrated onto the terminal device. That is, in the spectrum detector of the embodiments of the of the present disclosure, by fitting two elements with a two-dimensional step structure, a Fabry-Perot cavity array with a three-dimensional step structure is formed, and is simple in structure and can be easily processed and realized; in addition, the spectrum detector is integrated onto a portable terminal device, which is convenient for users to use at any time and enriches the functions of the terminal device.

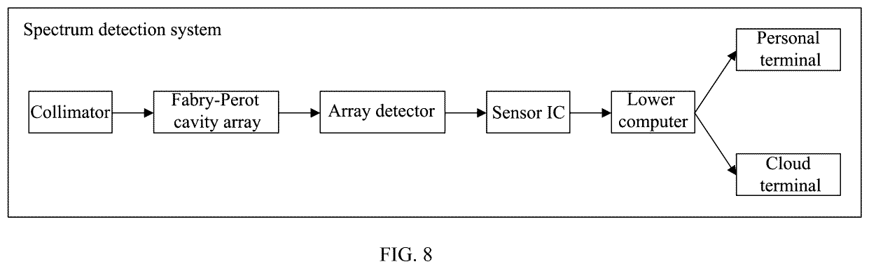

In a fifth aspect, the present disclosure provides a method of manufacturing a Fabry-Perot cavity array. FIG. 9 is a schematic flow chart of a method of manufacturing a Fabry-Perot cavity array provided by the present disclosure. The Fabry-Perot cavity array according to the first aspect is manufactured by this method. As shown in FIG. 9, the manufacturing method includes the following steps.

Step 101: manufacturing a first element having a first step and a second element having a second step, where the first step and the second step are a two-dimensional step structure.

Specifically, for an element with a step height in an order of micron, a process such as gray-scale lithography, laser direct writing, additive manufacturing, or precision machining can be used for manufacturing; and for an element with a step height in an order of nanometer, a gray-scale electron beam exposure, overlaying by lithography machine in cooperation with etching equipment, plating by mask in cooperation with PVD (e.g., magnetron sputtering, electron beam evaporation, etc.), etc. may be used. These processes belong to prior art and will not be described herein.

Step 102: plating a step surface of the first step and a step surface of the second step.

Specifically, the step surface of the first step of the first element and the step surface of the second step of the second element may be plated by using the prior art, which is similar to the above, and will not be described herein.

Step 103: arranging a first step side of the first element opposite to a second step side of the second element.

Where a step height change direction of the first step is different from a step height change direction of the second step.

Specifically, the two elements having a step structure are adhered together by an ultraviolet curing glue. A specific process includes the following steps: placing one of a first element 22 and a second element 23 on a base plate and applying a glue thereto onto a surface thereof away from the base plate, then placing the other element thereon for pressing downward, and after cleaning overflowed glue, curing under ultraviolet light. It should be noted that when fitting, it is necessary to make sure that a step direction of the first step is different from a step direction of the second step.

As an embodiment, the method further includes: arranging a preset number of elements on the first element or the second element, the preset number of elements being sequentially arranged in series; where each element among the preset number of elements has a two-dimensional step structure, and a step surface of the two-dimensional step structure is plated with a reflective film.

Specifically, a plurality of elements may be arranged on the first element or the second element, each of the plurality of elements has a two-dimensional step structure, and the plurality of elements are also sequentially arranged in series, so as to form an array of series-connected Fabry-Perot cavities.

The method of manufacturing a Fabry-Perot cavity array provided by the embodiments of the present disclosure includes: manufacturing a first element having a first step and a second element having a second step, where the first step and the second step are a two-dimensional step structure; plating a step surface of the first step and a step surface of the second step; arranging a first step side of the first element opposite to a second step side of the second element, where a step height change direction of the first step is different from that of the second step. That is, in the embodiments of the present disclosure, the Fabry-Perot cavity array with a three-dimensional step structure is not directly formed, but is formed by fitting two elements with a two-dimensional step structure, which simplifies the processing of the Fabry-Perot cavity array and breaks the limitation on the number of Fabry-Perot cavities in the Fabry-Perot cavity array.

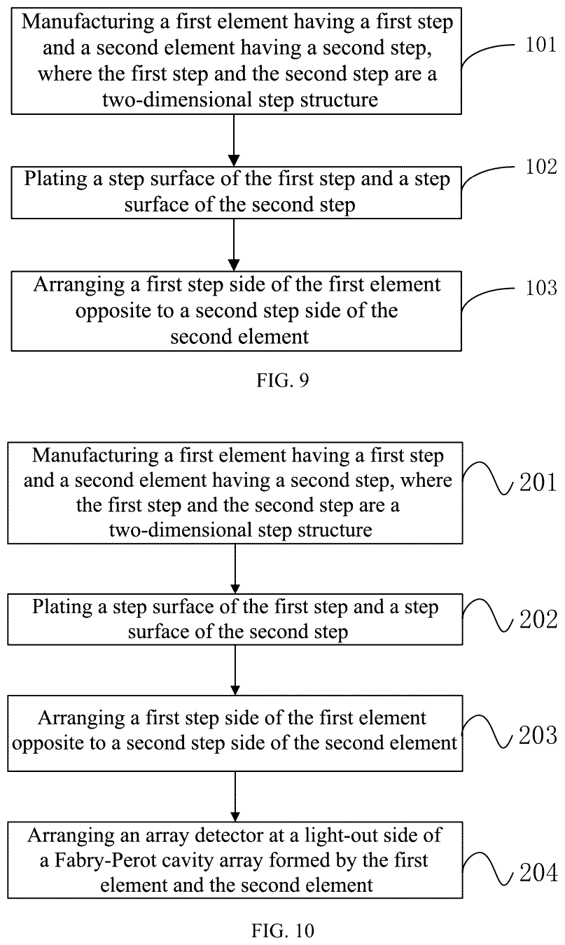

In a sixth aspect, the present disclosure provides a method of manufacturing a spectrum detector. FIG. 10 is a schematic flowchart of a method of manufacturing a spectrum detector provided by the present disclosure. The spectrum detector according to the second aspect is manufactured by this method. As shown in FIG. 10, the manufacturing method includes the following steps:
Step 201: manufacturing a first element having a first step and a second element having a second step, where the first step and the second step are a two-dimensional step structure;
Step 202: plating a step surface of the first step and a step surface of the second step,
Step 203: arranging a first step side of the first element opposite to a second step side of the second element, and
Step 204: arranging an array detector at a light-out side of the Fabry-Perot cavity array formed by the first element and the second element.

Steps 201, 202, and 203 in the present embodiment are implemented in a similar manner to steps 101, 102, and 103 in the manufacturing method of the Fabry-Perot cavity array in the aforementioned embodiment, and will not be described herein.

Different from the foregoing embodiments, an array detector is arranged at a light-out side of the Fabry-Perot cavity array formed by the first element and the second element. Specifically, the array detector may be closely fitted with the Fabry-Perot cavity array, or they may be fixed by a mechanical structure.

As an embodiment, the method further includes: arranging a preset number of elements on the first element or the second element, the preset number of elements being sequentially arranged in series; where each element in the preset number of elements has a two-dimensional step structure, and a step surface of the two-dimensional step structure is plated with a reflective film. Accordingly, step 204 includes: arranging an array detector on a light-out side of the Fabry-Perot cavity array formed by the preset number of elements, the first element, and the second element.

Specifically, an array detector may be arranged at a light-out side of a series structure Fabry-Perot cavity array formed by the preset number of elements, the first element, and the second element.

The method of manufacturing a spectrum detector provided by the embodiments of the present disclosure includes: manufacturing a first element having a first step and a second element having a second step, where the first step and the second step are a two-dimensional step structure; plating a step surface of the first step and a step surface of the second step; arranging a first step side of the first element opposite to a second step side of the second element, where a step height change direction of the first step is different from a step height change direction of the second step; and arranging an array detector at a light-out side of the Fabry-Perot cavity array formed by the first element and the second element. That is, in the embodiments of the present disclosure, during the manufacture of the Fabry-Perot cavity array of the spectrum detector, the Fabry-Perot cavity array with a three-dimensional step structure is not directly formed, but is formed by fitting two elements with a two-dimensional step structure, which simplifies the processing of the Fabry-Perot cavity array and breaks the limitation on the number of Fabry-Perot cavities in the Fabry-Perot cavity array.

Finally, it should be noted that the above embodiments are only for illustrating the technical solutions of the present disclosure, rather than to limit them. Although the present disclosure has been described in detail with reference to the foregoing embodiments, it will be understood by one having ordinary skill in the art that the technical solutions described in the foregoing embodiments may still be modified, or some or all of the technical features therein may be equivalently replaced. However, these modifications or replacements do not cause the essence of the corresponding technical solutions to depart from the scope of the technical solutions of the embodiments of the present disclosure.

What is claimed is:

1. A Fabry-Perot cavity array, comprising:
a first element having a first step and a second element having a second step,
wherein the first step and the second step are a two-dimensional step structure;
a first step side of the first element is arranged opposite to a second step side of the second element, and a step height change direction of the first step is different from a step height change direction of the second step; and
a step surface of the first step and a step surface of the second step are plated with a reflective film.

2. The Fabry-Perot cavity array according to claim 1, wherein the step height change direction of the first step is perpendicular to the step height change direction of the second step.

3. The Fabry-Perot cavity array according to claim 1, wherein the first step is recessed from a surface of the first element, and the second step is recessed from a surface of the second element;
or, the first step protrudes from a surface of the first element, and the second step is recessed from a surface of the second element;
or, the first step is recessed from a surface of the first element, and the second step protrudes from a surface of the second element.

4. The Fabry-Perot cavity array according to claim 1, wherein the first step or the second step comprises at least two steps having different heights.

5. The Fabry-Perot cavity array according to claim 2, wherein the first step or the second step comprises at least two steps having different heights.

6. The Fabry-Perot cavity array according to claim 1, wherein the first step or the second step is a redundant structure, wherein the redundant structure is used to characterize that among a plurality of steps of the first step or the second step, at least two steps have the same height.

7. The Fabry-Perot cavity array according to claim 2, wherein the first step or the second step is a redundant structure, wherein the redundant structure is used to characterize that among a plurality of steps of the first step or the second step, at least two steps have the same height.

8. The Fabry-Perot cavity array according to claim 1, wherein the reflective film is a single-layer film.

9. The Fabry-Perot cavity array according to claim 1, wherein a material of the first element or the second element is one of the following: glass, quartz, aluminum oxide Al₂O₃, polymethyl methacrylate PMMA or photoresist.

10. The Fabry-Perot cavity array according to claim 1, wherein the Fabry-Perot cavity array further comprises a preset number of elements arranged on the first element or the second element, and the preset number of elements are sequentially arranged in series;
wherein each element among the preset number of elements has a two-dimensional step structure, and a step surface of the two-dimensional step structure is plated with a reflective film.

11. A spectrum detector, comprising the Fabry-Perot cavity array according to claim 1 and an array detector,
wherein the array detector is arranged at a light-out side of the Fabry-Perot cavity array.

12. The spectrum detector according to claim 11, further comprising a collimator arranged at a light-in side of the Fabry-Perot cavity array.

13. The spectrum detector according to claim 11, wherein the array detector is one of the following: a charge-coupled device sensor array, a complementary metal oxide semiconductor sensor array, a thermal sensor array, a photodiode array, an avalanche photodetector array and a photomultiplier tube array.

14. A spectrum detection system, comprising the spectrum detector according to claim 11 and a reconstruction device,
wherein the reconstruction device is configured to perform reconstruction processing on an optical signal outputted by the spectrum detector, so as to obtain spectrum information.

15. The spectrum detection system according to claim 14, further comprising a storage device, wherein the storage device is configured to store the spectrum information.

16. A terminal device, which is integrated thereon with the spectrum detector according to claim 11.

17. A method of manufacturing a Fabry-Perot cavity array, comprising:
manufacturing a first element having a first step and a second element having a second step, wherein the first step and the second step are a two-dimensional step structure;
plating a step surface of the first step and a step surface of the second step; and
arranging a first step side of the first element opposite to a second step side of the second element, wherein a step height change direction of the first step is different from a step height change direction of the second step.

18. The method according to claim 17, further comprising:
arranging a preset number of elements on the first element or the second element, the preset number of elements being sequentially arranged in series;
wherein each element among the preset number of elements has a two-dimensional step structure, and a step surface of the two-dimensional step structure is plated with a reflective film.

19. A method of manufacturing a spectrum detector, comprising:
manufacturing a first element having a first step and a second element having a second step, wherein the first step and the second step are a two-dimensional step structure;
plating a step surface of the first step and a step surface of the second step;
arranging a first step side of the first element opposite to a second step side of the second element, wherein a step height change direction of the first step is different from a step height change direction of the second step; and
arranging an array detector at a light-out side of the Fabry-Perot cavity array formed by the first element and the second element.

20. The method according to claim 19, further comprising:
arranging a preset number of elements on the first element or the second element, the preset number of elements being sequentially arranged in series; wherein each element among the preset number of elements has a two-dimensional step structure, and a step surface of the two-dimensional step structure is plated with a reflective film; and
then the arranging the array detector at the light-out side of the Fabry-Perot cavity array formed by the first element and the second element comprises:
arranging the array detector at the light-out side of the Fabry-Perot cavity array formed by the preset number of elements, the first element and the second element.
